(19) United States
(12) Patent Application Publication
(10) Pub. No.: US 2019/0260573 A1
(43) Pub. Date: Aug. 22, 2019

(54) Computerized Method For Managing Product Such As Wine and Cigar Utilizing Micro Chip Implanted Container and Blockchain Ledger System

(71) Applicant: Arisa Goto, Redondo Beach, CA (US)

(72) Inventor: Arisa Goto, Redondo Beach, CA (US)

(21) Appl. No.: 16/278,197

(22) Filed: Feb. 18, 2019

Related U.S. Application Data
(60) Provisional application No. 62/631,783, filed on Feb. 18, 2018.

(51) Int. Cl. H04L 9/06; G06Q 10/08; G06K 19/06; G06F 16/18; H04L 9/32

(52) U.S. Cl. CPC H04L 9/0637; G06Q 10/0833; H04L 2209/38; G06F 16/1805; H04L 9/3226; G06K 19/06037

(57) ABSTRACT

Methods and systems for allowing a cryptographic, co-processors implemented Contactless or Dual Interface Chip implanted bottle of wine and blockchain system to build a public ledger for recording and storing collection of transaction history and or distribution history in wine market.

### TECHNICAL FIELD

Certain embodiments of the present disclosure generally relate to data processing and, more particularly, to the method and system provided for participants of wine market to record and share information on a shared online ledger system employing blockchain structure in order to track wine throughout distribution channel.

### BACKGROUND

For centuries, world wine industry has been the center of fraud from cooperage to asset misappropriation, mislabeling fraud, raw material fraud, collector fraud, misleading consumers, and the list goes on. While the U.S. wine industry is highly regulated requiring detailed recordkeeping starting with the weight tickets at harvest and ending when the wine is available for sale, lack of oversight to secondary market and international market create vulnerability to free rider problems and making it easy for wine fraudsters to take advantage of opportunities for quick money. Bottles of wine being especially differentiated product, brand protection in market place is one of the most important steps that can be taken by the wine industry. The Declaration to Protect Wine Place and Origin, commonly known as the Napa Declaration on Place, is a “declaration of joint principles stating the importance of location to wine and the need to protect place names.” The declaration group reports that 96 percent of wine consumers say that consumers deserve to know the location where wine grapes are grown. Outside the traditional wine growing area of Europe and the Middle East, wine grapes can only be grown successfully between the 30th and 50th degree latitude in both Northern and Southern hemisphere, in U.S. specific viticultural areas in New York and California have clearly defined geographical, climatic and soil features to create world class wine, also coastal vineyards affected with cold-water current are known capable of producing age worthy, world best wines. Such areas include the cold West Coast of North America where the California Current flows along, Peru Current bringing fog to the Chilean Coast, the Benguela Current flowing off the West Coast of South Africa, West Australian current also a cold-water current that flows to the Australian continent's West Coast. In the United States, American Viticultural Area (AVA) is the official appellation that is designated as wine grape-growing region. While grapes for non-premium wines tend to grow on flat plots and mechanically harvested, great grapes for premium wines tend to grow on hills (higher elevation where radiation inversion form on nights) and hand-harvested. Thus, wines from particular regions, certain wineries and certain grape varieties and from certain vintage years are often in short supply and high in demand, creating high dollar value per bottles for end consumers.

Also, how properly wines may be routed to consumers may add extra value to a bottle of wine, especially because wine storage facilities should be cooled but not refrigerated at the ideal temperature. Traditionally with 3-tier system, wineries route customer orders through a certified distributor where a heavy-duty truck with cooling may be used to deliver wine from an onsite Winery's Warehouse to a Distributor Warehouse. However, with recent growth of direct sales (DtC) channels in U.S. wine market, and also when most wineries choosing to outsource fulfillment to Third-party logistics (3PLs). In addition to wine clubs, more wines are sold over online where most of them maintain warehouse, others offer wine with greatly reduced price, also online wine market place. It has become a great interest to consumers of how wines are transported and stored before they reach end customers? Do they know what they are doing? For example, a 3PL companies may use courier delivery service such as FedEx, UPS and etc., where customers choose between non-temperature controlled air shipping and non-temperature controlled ground based delivery via truck making stops at non-temperature controlled service center of courier delivery service, in both case presumably packed in a proprietary multi-day temperature-regulating packaging.

Unfortunately in conventional systems, there is not a platform that enables end-to-end visibility on tracking a bottle of wine through distribution channel such as how condition controlled the transportation and storage had been. Why is that? In conventional systems, when a bottle of wine is passed to next link in the distribution channel, input data is entered into a data repository system at entities involved, where end consumer may not be able to access such information. This is because in a distribution channel, each link in the chain may be a supplier for a following link, at the same time, each link may be a customer for a link before in the chain, which make the end customer to be a customer only for the link before and not a customer for all other intermediaries of the distribution channel. Which often make end customers not fan of intermediary links, but afterall, links in the distribution channel are adding value to the products while passing products along the distribution channel. Why not share such data across different participants of wine market, up dated in real time? If such platform is available, in the near future, AI software may be able to detect, spot and alert frauds much faster which will contribute to make wine market much safer and consumer friendly place.

### SUMMARY OF THE DISCLOSURE

Certain embodiments provide a method and system generally including creating a shared database ledger by allowing a computer network to serve as a system to build a blockchain ledger for recording and storing collections of information regarding a distribution channel of a bottle of wine that is highly available to all participants in the wine market. This shared database enables visibility and support check-and-balances within a group of separate entities and individual participants on a network where conflict of interest may exist.

Certain embodiments provide a method and system generally including creating a computer network system including but not limited to peer to peer distributed network system.

Certain embodiments provide a method and system generally including recording a distribution history and or transaction history by appending a set of individual information to an append-only database ledger in chronological order.

Certain embodiments provide a cryptographic co-processors implemented Contactless or Dual Interface Chip implanted bottle of wine employing methods to authenticate a set of non-changing data about a bottle of wine, such as vintage, appellation and etc., and also generate verification of a changing status of a bottle of wine in its distribution channel (i.e. end of transportation by truck to, start of warehouse storage in a location).

Certain embodiments provide a method and system generally including a method for signing and verification of individual bottle of wine and confirming change of status in the distribution channel.

Certain embodiments provide a method and system generally including creating a timestamp to prove when a change of status in the distribution channel had happened.

Certain embodiments provide a method and system generally including creating a unique cryptographic hash of an input data object, in response to receiving the confirmation of a change of status in the distribution channel.

Certain embodiments provide a method and system generally including a mechanism of Merkle Tree in order to store a record of input data in a blockchain ledger.

Certain embodiments provide a method and system to generate QR code in order for anyone to access information in the blockchain.

Certain embodiments provide a method and system to assign PIN number for the owner of the bottle of wine in order to requiring PIN number entry at transaction or process of creating new Input on the blockchain.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates an example online communication system, in accordance with certain embodiments of the present disclosure.

FIG. 2 illustrates an example structure of blockchain with embodiments of the present disclosure.

FIG. 3 illustrates an example operation of process to prepare and initiate origin block of blockchain, in accordance with certain embodiments of the present disclosure.

FIG. 4 illustrates an example method record keeping process to a blockchain, in accordance with embodiments of the present disclosure.

FIG. 5 illustrates an example operation of process to operate authentication of a bottle of wine, in accordance with embodiments of the present disclosure.

FIG. 6 illustrates an example method blockchain structure, in accordance with embodiments of the present disclosure.

FIG. 7 illustrates an example screen interface for viewing content recorded in a block of blockchain, in accordance with certain embodiments of the present disclosure.

### DETAILED DESCRIPTION

Embodiments of the present disclosure may allow a computer network to serve as a system to build a ledger for recording and storing collections of transaction history of a bottle of wine that is stable, fault tolerant and highly available to all participants in the wine market in order to support visibility, check and balances within the system. Certain embodiments may provide a peer-to-peer distributed system where nodes are connected to peers without centralized data store in a single server, which with its architecture eliminates the single point of failure. For some embodiments, the shared database ledger may also provide append-only database ledger where transaction history of wine is recorded only by appending a set of individual transaction on the blockchain ledger system.

Embodiments of the present disclosure may allow a cryptographic co-processors implemented Contactless or Dual Interface Chip implanted bottle of wine employing both Static Data Authentication (SDA) and Dynamic Data Authentication (DDA). Static Data Authentication (SDA) may provide to authenticate a set of non-changing data of the bottle of wine. Certain embodiments may also provide a method and system to Dynamic Data Authentication (DDA) allowing authentication of changing transaction data (i.e. unpredictable and transaction-dependent data) may be processed at the point of transaction. For some embodiments, may also employ public key cryptography based on asymmetric cryptograms (i.e. RSA, ECDSA, DSA and etc.) in order to verify a transaction data processed by Dynamic Data Authentication (DDA) at the point of transaction.

Embodiments of the present disclosure may employ blockchain technology to record data that is immutable and highly available to all participants in the wine market. As used herein, the term “blockchain” generally refers to append-only database ledger where permanently-retained and immutable historical data

As a result, the method and system provided herein may help to provide visibility and transparency to wine market and may also help discourage frauds.

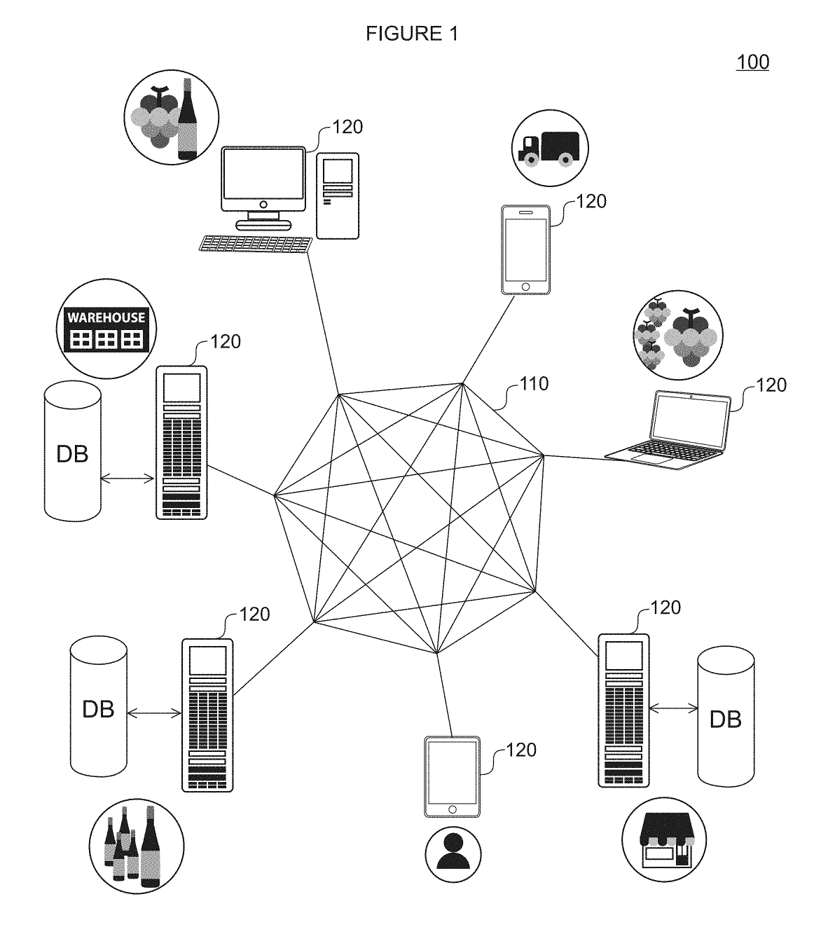

FIG. 1 illustrates an example of a computer network 100 in which embodiments of the present disclosure may be employed.

FIG. 1 depicts various independent entities and individual participants 120 which may include but not limited to participants such as wineries, Distributors, Third Party Logistic providers, Package Carriers, Warehouses, Merchants, Retails, Consumers, Wine Cellars and Collectors, of wine market throughout a computer network 110.

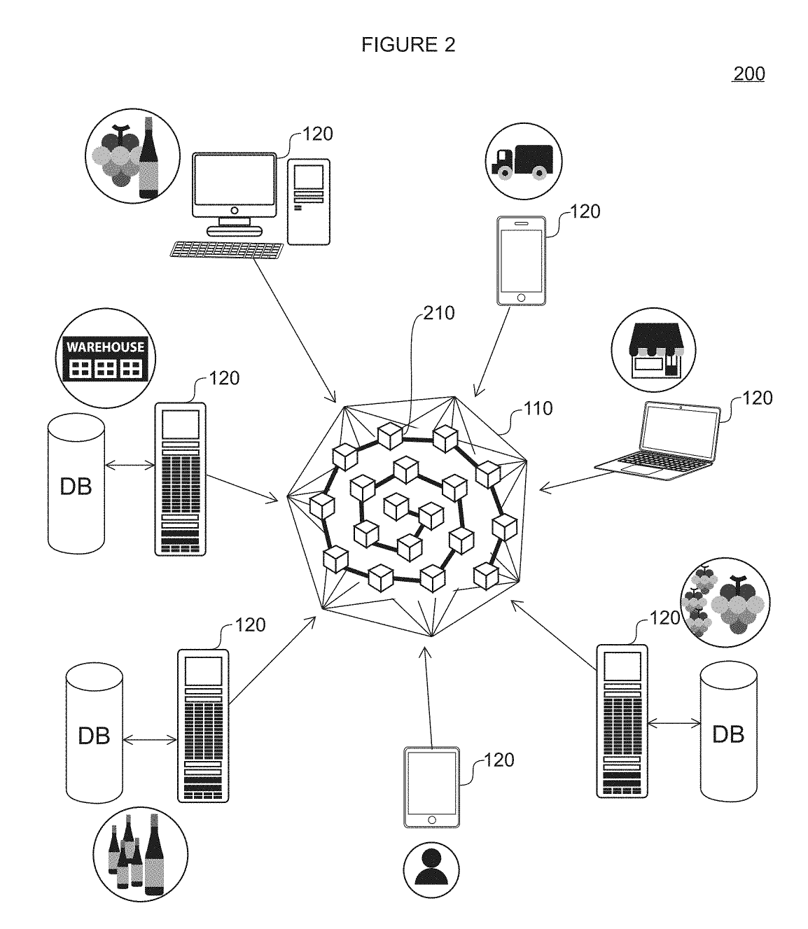

As illustrated in FIG. 2, a structure of linear connection of a blockchain 210 of a group of fragmented blocks, may be overlaid with the computer network 110. Although building blocks of a blockchain 210 are dispersed throughout a computer network 110, new blocks are always stored chronologically creating a linear order of blocks.

In conventional systems, when a bottle of wine is passed to next link in the distribution channel, input data is entered into a data repository system at entities involved where end consumer may not be able to access such information. If one wanted to search footprint of a wine in distribution channel or through supply chain, one must obtain information from different systems owned by different entities. Blockchain ledger make such information available to end consumer at any time.

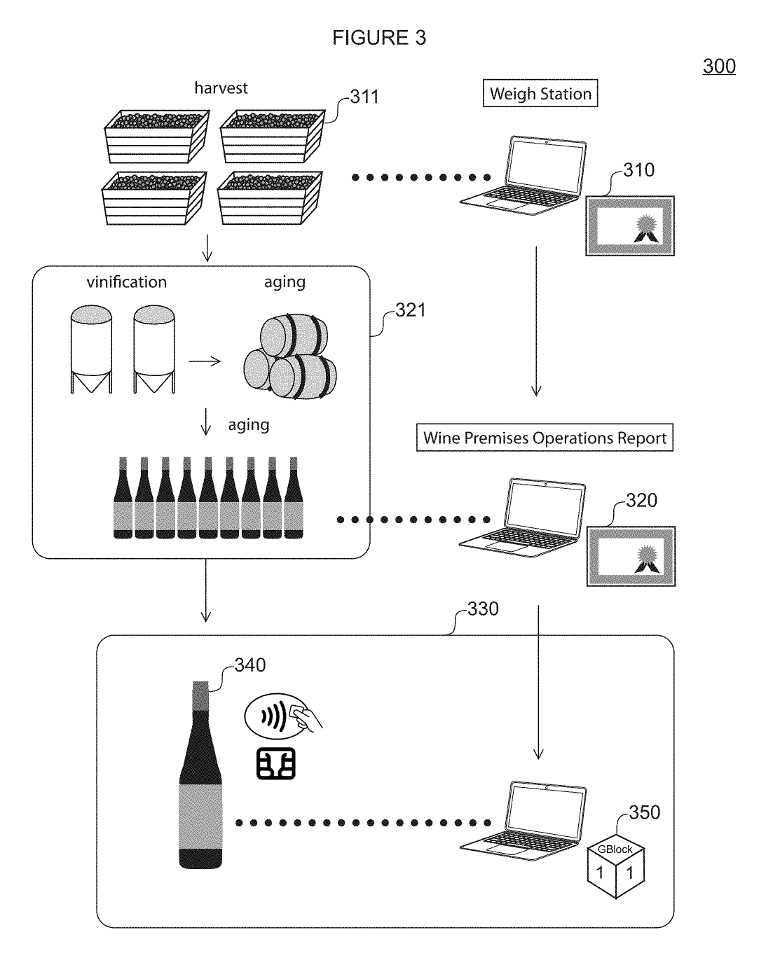

FIG. 3 illustrates an example of steps that may be taken in order to initiate the first block for the blockchain ledger.

Tracking the production of wine in the United States falls under the auspices of the federal Alcohol and Tobacco Tax and Trade Bureau (TTB). Harvested grapes 311 are weighed at a certified weigh station and issued certificate of accuracy 310 so that a record is available about, tonnage, grape varietal and vineyard origin. Such data may be added in a set of non-changing data on Static Data Authentication (SDA) system.

Report of Wine Premises Operations 320 requires information on various categories of losses from process of productions, vinification must be documented so that a record is available, as to the variety, vintage and appellation of origin to maintain the comparison basis with the original tonnage amount. Also, information on method of production 321 such as aging in barrels and bottle aging may be retained at a winery. Such data may be added in a set of non-changing data on Static Data Authentication (SDA) system as well.

IC chip employed bottle 340 may be utilized in order to authenticate the wine. Non-changing data such as; producer of the wine, net volume, vintage, varietal(s) of grape(s), appellation, etc. may be loaded on the IC chip and the first block of blockchain (the Origin Block) 350 in the blockchain, at Block integration Operation 330.

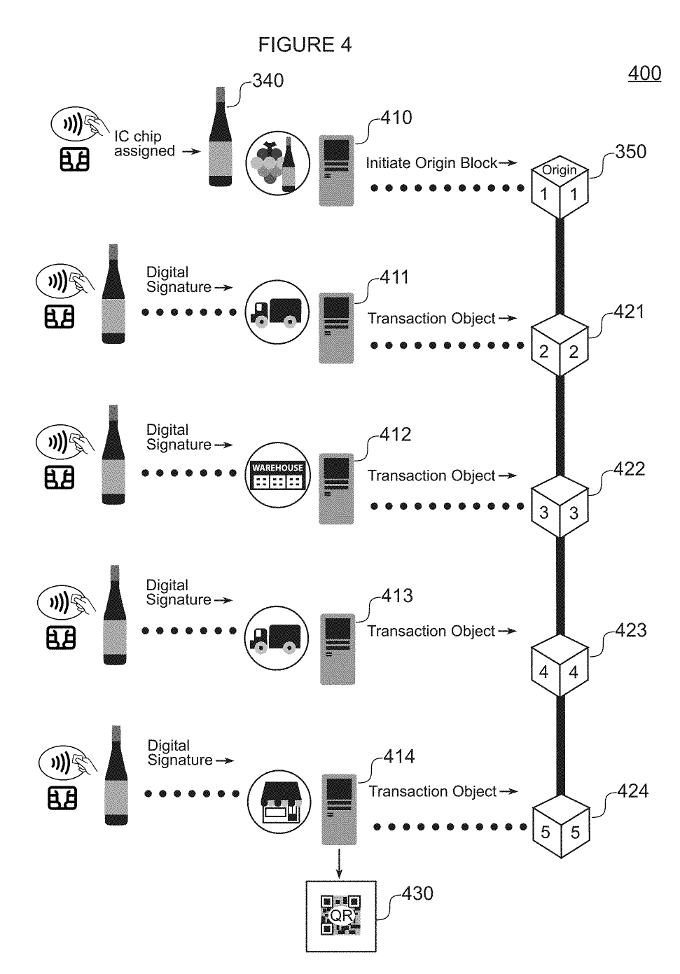

FIG. 4 illustrates an example of how an IC chip Reader 410 may be used to scan information and generate Input Information Object to create new block in a blockchain.

FIG. 4 depicts various links within a distribution rout where a bottle of wine may be scanned. IC Chip employed bottle 340 may be scanned with IC Chip reader 410 on site to generate Transportation Inputs or Storage Inputs. For example, after an Origin block 350 is initiated at a winery, a midsized truck 411 may be used to transport wine from the winery to a distributor's warehouse 412. IC chip scanner of the trucking company 411 will generate Transportation Input, then verify digital signature generated by IC chip implanted wine 340 in order to prove that the wine was present on site, if the wine's authentication is verified, Transportation Input Object is created added to a block 421 of a blockchain. On the site of warehouse, IC chip scanner 412 of the warehouse company will generate Storage Inputs, then verify digital signature generated by IC chip implanted wine 340 in order to prove that the wine was present on site, if the wine's authentication is verified, Transportation Input Object is created added to a block 422 of a blockchain. A midsized truck 413 may be used to transport wine from the winery to a retail store 414. IC chip scanner of the trucking company 413 will generate Transportation Inputs, then verify digital signature generated by IC chip implanted wine 340 in order to prove that the wine was present on site, if the wine's authentication is verified, Transportation Input Object is created added to a block 423 of a blockchain. On the site of retail store, IC chip scanner 414 of the warehouse company will generate Storage Inputs, then verify digital signature generated by IC chip implanted wine 340 in order to prove that the wine was present on site, if the wine's authentication is verified, Transportation Input Object is created added to a block 424 of a blockchain. When a distribution link meet the end consumer, QR code 430 may be printed on a card or on a sticker to place on the bottle. QR code 430 may be scanned to access the address created to review non-changing information about the wine and history of transportation and storage in a chronological order.

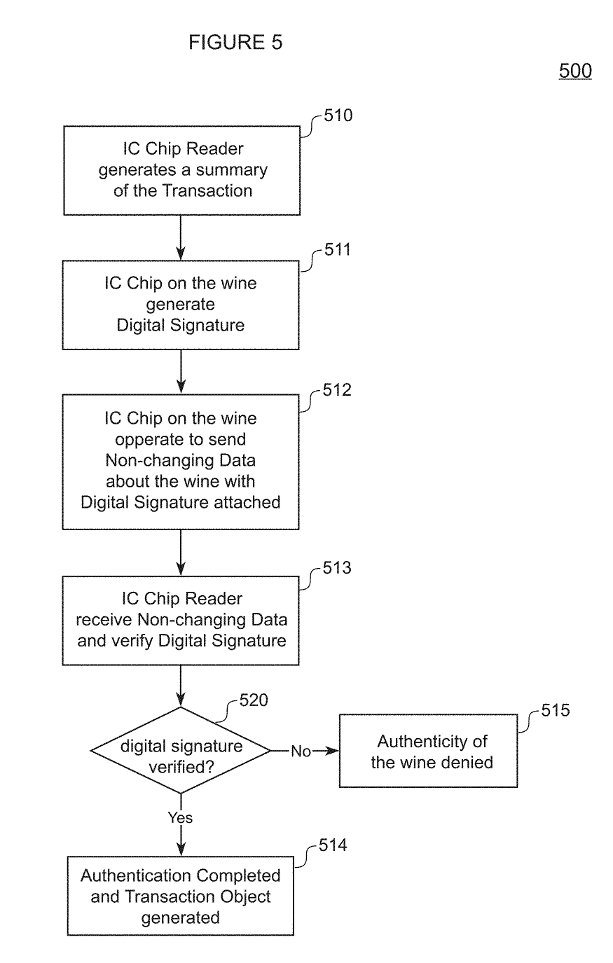

FIG. 5 illustrates example operations 500 that may be performed, for example, on site of IC Chip Reader 411 for trucking company, IC chip scanner of the trucking company 411 will generate Transportation Input, then verify digital signature sent from IC chip implanted wine 340 in order to prove that the wine was present on site, if the wine's authentication and Transportation Input is verified, Transportation Input Object is created added to a block 421 of a blockchain, in accordance with certain embodiments of the present disclosure.

The operations 500 begin, at 510, by Contactless or Dual Interface Chip Reader scans and identify the wine, then generates a summary of an Input Document. A cryptographic co-processors implemented Contactless or Dual Interface Chip implanted bottle of wine receives the Input Document and operate to generate Digital Signature, attach Digital Signature to the Input Document send back with Digitally Signed Input Document 511, then IC Chip Reader receives Digitally Signed Input Document, start operation to verify the Digital Signature. If a Digital Signature is verified as determined at 520, Digitally Signed Input Document Object is created, at 514.

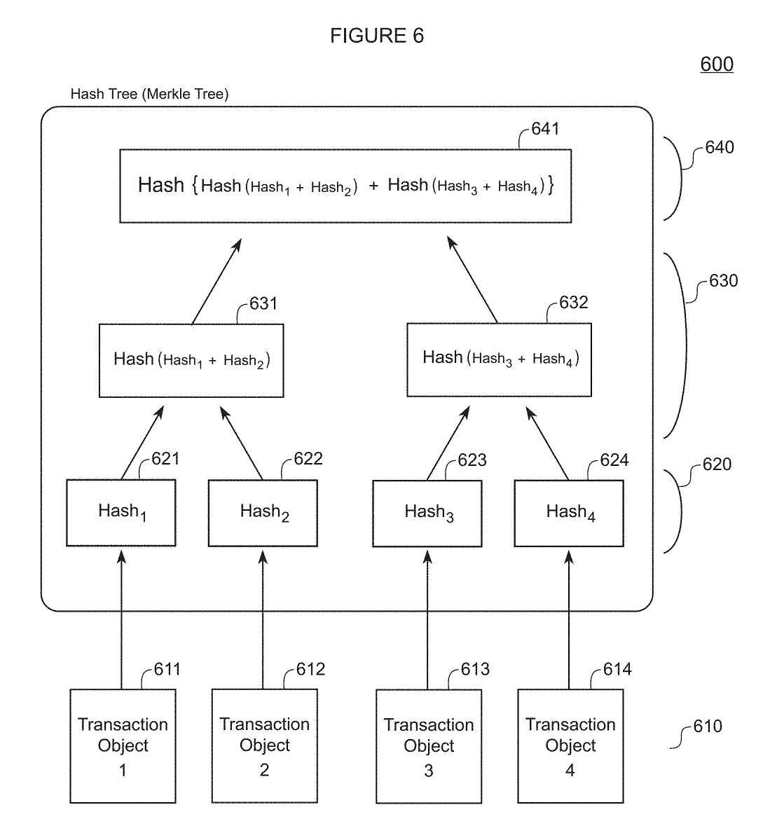

FIG. 6 illustrates example data structure of connection of Digitally Signed Input Document Object in Merkle Tree (Hash Tree) format, where each leaf node is a hash of an Input Document Object, and each non-leaf node is a hash of its child nodes. The tree structure maintains the order that data is added to the tree. The advantage of Merkle Tree structure is that validity of the data in a tree branch can be validated faster than a list structure. Also hashing takes any text, no matter how long it is and converts it into an array of numbers and letters through an algorithm.

Each blocks added in the Data blocks 610 are being hashed in order to convert Input Data Object into fixed sized string of text. The advantage of hashing is, it takes any text, no matter how long it is and converts it into an array of numbers and letters. Cryptographic hash function including but not limited to one of SHA-2 may be used.

Each blocks added in the Data blocks 610 are being hashed using some cryptographic hash function. After receiving a new Input Document Object 614, it is added at the end of Data Blocks 610. Input Document Object 614 is hashed transforming to Leaf Node 624, added to the Leaf Nodes 620 of Merkle Tree (Hash Tree) 650. Then Leaf Node 624 is paired with Leaf Node 623 to be hashed to create Internal Node 632. Then Internal Node 632 is paired with Internal Node 631 to be hashed to create Node 641. Node 641 is the only one remaining in the tree making it a Root Node. It is a generalization of hash lists and hash chains:

### Has {Hash (Hash1+Hash2)+Hash (Hash3+Hash4)}.

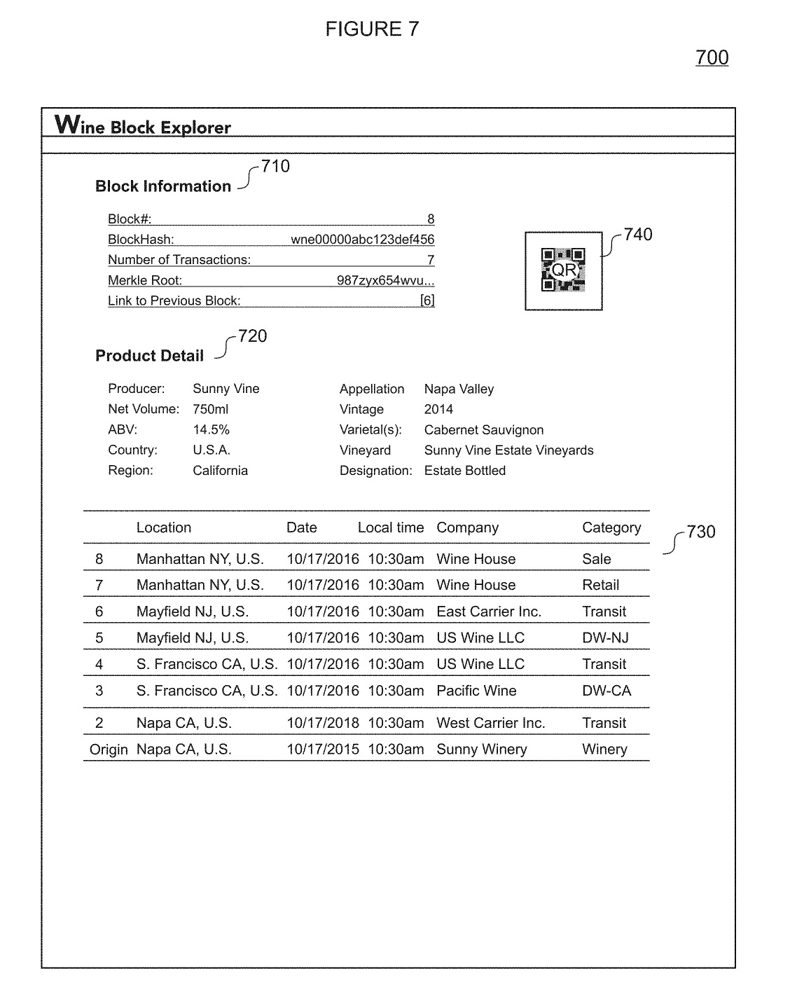

FIG. 7 illustrates example user interface 700, which allows users 120 to view information about the block 710, non-changing information about the wine 720, a log of Input Documents 730, and QR Code for the address of the block 740.

The Input Data entered into the blockchain is immediately available to be viewed online. Certain embodiments allow end customers to search for a block in the blockchain by scanning QR Code provided at the point of sale 430.

User interface 700 may include information regarding certain block of a blockchain 710 such as current block number, block hash, number of inputs made, hash for Merkle Root in order to prove current block's authenticity.

User interface 700 may include non-changing information about the wine 720 such as name of producer (winery), net volume of the product, ABV, Country of origin, Region, Appellation, Vintage year, Varietal(s) of grape(s), Vinyard and special designation such as Estate Bottled.

User interface 700 may include logs of Storage/Transport Inputs 730. Certain embodiments allow end customers to view historical footprints of the wine starting from winery with information including but not limited to; Input Number (Block number), Location, Date, Local Time, Company, Category (Transport/Storage).

User interface 700 may also include QR Code 740 of the Address of the block in order to allow users to send link to others to share information in the block.

1. System and methods that allow a cryptographic co-processors implemented Contactless or Dual Interface Chip implanted bottle of wine and blockchain system to build a public ledger for recording and storing collection of transaction history and or distribution history.

2. The method of claim 1, wherein enabling to record information in append-only ledger implementing Merkle Tree or Hash Tree structure.

3. The method of claim 1, wherein enabling to create an Input Data based on transportation status of a bottle of wine.

4. The method of claim 1, wherein enabling to create an Input Data based on storage status of a bottle of wine.

5. The method of claim 1, wherein enabling to generate QR code in order for anyone to access information in the blockchain.

6. System and methods that allow a cryptographic co-processors implemented Contactless or Dual Interface Chip implanted bottle of wine and Contactless or Dual Interface Chip Reader in collaboration of exchanging, generating and verifying information allowing, Contactless or Dual Interface Chip Reader to authenticate the bottle of wine and, generate Input Data to be added to blockchain, also, Contactless or Dual Interface Chip implanted bottle of wine to generate digital signature and, store encrypted Input Data.

7. The method of claim 6, wherein employing cryptographic operation based on asymmetric cryptograms.

8. System and methods that enabling an owner of a cryptographic co-processors implemented Contactless or Dual Interface Chip implanted bottle of wine to protect ledger by requiring PIN number entry at transaction or process of creating new Input on the blockchain.
